(19) United States
(12) Patent Application Publication
(10) Pub. No.: US 2026/0313434 A1
(43) Pub. Date: Oct. 8, 2026

(54) WIRELESS COMMUNICATION METHOD AND APPARATUS, AND COMMUNICATION DEVICE AND STORAGE MEDIUM

(71) Applicant: Beijing Xiaomi Mobile Software Co., Ltd., Beijing (CN)

(72) Inventors: Jinhua WU, Beijing (CN); Yang SHEN, Beijing (CN); Deqian WANG, Beijing (CN); Jianning LIU, Beijing (CN); Yuxin MAO, Beijing (CN)

(73) Assignee: Beijing Xiaomi Mobile Software Co., Ltd., Beijing (CN)

(21) Appl. No.: 18/998,405

(22) PCT Filed: Jul. 25, 2022
(86) PCT No.: PCT/CN2022/107718

§ 371 Date: Jan. 24, 2025

(51) Int. Cl. H04W 28/02

(52) U.S. Cl. CPC H04W 28/0221; H04W 28/0268

(57) ABSTRACT

The embodiments of the present disclosure provide a wireless communication method, which is performed by a base station. The method includes: obtaining terminal status information from a first network function; and updating a quality of service (Qos) specification for a first service according to the terminal status information.

### CROSS REFERENCE TO RELATED APPLICATIONS

The present application is a U.S. national phase of International Application No. PCT/CN2022/107718, filed on Jul. 25, 2022, the disclosure of which is incorporated herein by reference in its entirety.

### TECHNICAL FIELD

The present disclosure relates to, but is not limited to, the field of wireless communication technology, and in particular to wireless communication methods and apparatuses, a communication device and a storage medium.

### BACKGROUND

With the development of wireless networks, a more efficient codec requires more power consumption and higher reliability, and higher throughput and lower latency budget also require more power consumption and more network resources. Hence, a trade-off of quality of experience (QoE) and device power consumption needs to be considered. There is no corresponding policy mechanism in the related technology to meet the above requirements.

### SUMMARY

According to a first aspect of the embodiments of the present disclosure, there is provided a wireless communication method, performed by a base station. The method includes: obtaining terminal status information from a first network function; and updating a quality of service (QoS) specification for a first service according to the terminal status information.

According to a second aspect of the embodiments of the present disclosure, there is provided a wireless communication method, performed by a terminal. The method includes: sending terminal status information to a second network function; where the terminal status information is configured to update a quality of service (QoS) specification for a first service.

According to a third aspect of the embodiments of the present disclosure, there is provided a wireless communication method, performed by a second network function. The method includes: receiving terminal status information sent by a terminal; where the terminal status information is configured to update a quality of service (QoS) specification for a first service.

According to a fourth aspect of the disclosed embodiment, there is provided a communication device. The communication device includes: one or more processors; and a memory for storing instructions executable by the processors, where the processors are configured to, when executing the instructions, implement the method described in any embodiment of the present disclosure.

According to a fifth aspect of the embodiments of the present disclosure, a computer storage medium is provided, which stores a computer executable program that, when executed by a processor, implements the method described in any embodiment of the present disclosure.

In the embodiment of the present disclosure, the terminal status information is obtained from the first network function; and the QoS specification for the first service is updated according to the terminal status information. Herein, after obtaining the terminal status information from the first network function, the base station can update the QoS specification for the first service based on the terminal status indicated by the terminal status information. Compared to always setting a fixed QoS specification for the first service, the QoS specification can be adapted to the terminal status, and a balance between experience quality and device power consumption can be achieved.

### BRIEF DESCRIPTION OF THE DRAWINGS

FIG. 1 is a schematic structural diagram of a wireless communication system according to an exemplary embodiment.

FIG. 2 is a flowchart of a wireless communication method according to an exemplary embodiment.

FIG. 3 is a flowchart of a wireless communication method according to an exemplary embodiment.

FIG. 4 is a flowchart of a wireless communication method according to an exemplary embodiment.

FIG. 5 is a flowchart of a wireless communication method according to an exemplary embodiment.

FIG. 6 is a flowchart of a wireless communication method according to an exemplary embodiment.

FIG. 7 is a flowchart of a wireless communication method according to an exemplary embodiment.

FIG. 8 is a flowchart of a wireless communication method according to an exemplary embodiment.

FIG. 9 is a flowchart of a wireless communication method according to an exemplary embodiment.

FIG. 10 is a flowchart of a wireless communication method according to an exemplary embodiment.

FIG. 11 is a flowchart of a wireless communication method according to an exemplary embodiment.

FIG. 12 is a flowchart of a wireless communication method according to an exemplary embodiment.

FIG. 13 is a flowchart of a wireless communication method according to an exemplary embodiment.

FIG. 14 is a flowchart of a wireless communication method according to an exemplary embodiment.

FIG. 15 is a flowchart of a wireless communication method according to an exemplary embodiment.

FIG. 16 is a flowchart of a wireless communication method according to an exemplary embodiment.

FIG. 17 is a flowchart of a wireless communication method according to an exemplary embodiment.

FIG. 18 is a flowchart of a wireless communication method according to an exemplary embodiment.

FIG. 19 is a flowchart of a wireless communication method according to an exemplary embodiment.

FIG. 20 is a flowchart of a wireless communication method according to an exemplary embodiment.

FIG. 21 is a flowchart of a wireless communication method according to an exemplary embodiment.

FIG. 22 is a schematic structural diagram of a wireless communication apparatus according to an exemplary embodiment.

FIG. 23 is a schematic structural diagram of a wireless communication apparatus according to an exemplary embodiment.

FIG. 24 is a schematic structural diagram of a wireless communication apparatus according to an exemplary embodiment.

FIG. 25 is a schematic structural diagram of a wireless communication apparatus according to an exemplary embodiment.

FIG. 26 is a schematic structural diagram of a wireless communication apparatus according to an exemplary embodiment.

FIG. 27 is a schematic structural diagram of a wireless communication apparatus according to an exemplary embodiment.

FIG. 28 is a schematic structural diagram of a wireless communication apparatus according to an exemplary embodiment.

FIG. 29 is a schematic structural diagram of a terminal according to an exemplary embodiment.

FIG. 30 is a block diagram of a base station according to an exemplary embodiment.

### DETAILED DESCRIPTION OF THE EMBODIMENTS

The exemplary embodiments will be described in detail herein, and examples thereof are shown in accompanying drawings. When the following descriptions refer to the accompanying drawings, unless otherwise indicated, the same numbers in different drawings represent the same or similar elements. The implementations described in the following exemplary embodiments do not represent all the implementations consistent with the embodiments of the present disclosure. Rather, they are merely examples of the apparatus and method consistent with some aspects of the embodiments of the present disclosure as detailed in the appended claims.

Terms used in the embodiments of the present disclosure are for the purpose of describing specific embodiments only, and are not intended to limit the embodiments of the present disclosure. The singular forms “a”, “an” and “this” used in the embodiments of the present disclosure and the appended claims are also intended to include plural forms, unless the context clearly indicates other meanings. It should also be understood that the term “and/or” as used herein refers to and includes any and all possible combinations of one or more of the associated listed items.

It should be understood that although terms first, second, third, and the like may be used in the embodiments of the present disclosure to describe various information, such information should not be limited to these terms. These terms are only used to distinguish the same type of information from each other. For example, first information may also be referred to as second information, and similarly, the second information may also be referred to as the first information without departing from the scope of the present disclosure. Depending on the context, the word “if” as used herein can be interpreted as “at the time of”, “when” or “in response to determining”.

For purposes of conciseness and ease of understanding, terms used herein are “greater than” or “less than” when representing a size relationship. However, it can be understandable for those skilled in the art that the term “greater than” covers the meaning of “greater than or equal to”, and “less than” covers the meaning of “less than or equal to”.

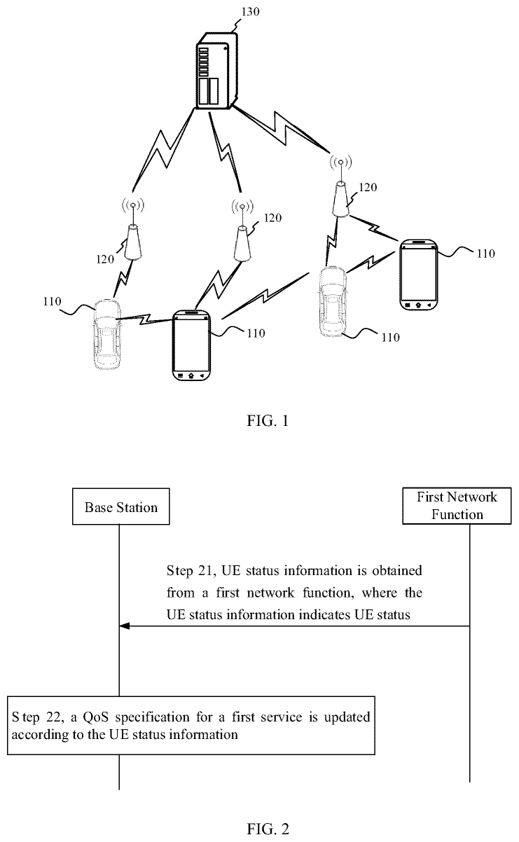

Referring to FIG. 1, FIG. 1 is a schematic structural diagram showing a wireless communication system provided in an embodiment of the present disclosure. As shown in FIG. 1, the wireless communication system is a communication system based on mobile communication technologies, and may include several user equipment (UEs) 110 and several base stations 120.

The UE 110 may be a device that provides voice and/or data connectivity to a user. The UE 110 may communicate with one or more core networks via a radio access network (RAN). The UE 110 may be an Internet of things UE, such as a sensor device, a mobile phone and a computer with an Internet of things UE. For example, the UE 110 may be a fixed, portable, pocket-sized, handheld, built-in computer or vehicle-mounted apparatus, for example, a station (STA), a subscriber unit, a subscriber station, a mobile station, a mobile, a remote station, an access point, a remote terminal, an access terminal, a user terminal, a user agent, a user device, or user equipment (UE). Or, the UE 110 may be a device of an unmanned aerial vehicle. Or, the UE 110 may be a vehicle-mounted device, for example, a driving computer with a wireless communication function, or a wireless communication device externally connected with a driving computer. Or, the UE 110 may be a roadside device, such as a street lamp, a signal lamp or other roadside devices with a wireless communication function.

The base station 120 may be a network side device in the wireless communication system. The wireless communication system may be a 4th generation mobile communication (4G) system, also referred to as a long term evolution (LTE) system. Or, the wireless communication system may be a 5G system, also referred to as a new radio (NR) system or a 5G NR system. Or, the wireless communication system may be a next generation system of the 5G system. The access network in the 5G system may be referred to as a new generation-radio access network (NG-RAN).

The base station 120 may be an evolved base station (eNB) used in the 4G system. Or, the base station 120 may be a centralized distributed architecture base station (gNB) used in the 5G system. When the base station 120 adopts the centralized distributed architecture, it usually includes a central unit (CU) and at least two distributed units (DUs). A protocol stack of a packet data convergence protocol (PDCP) layer, a radio link control (RLC) layer and a media access control (MAC) layer is provided in the central unit. A protocol stack of a physical (PHY) layer is provided in the distributed unit. The specific implementation of the base station 120 is not limited in the embodiments of the present disclosure.

A wireless connection may be established between the base station 120 and the UE 110 through a wireless radio. In different embodiments, the wireless radio is a wireless radio based on the 4th generation mobile communication network technology (4G) standard. Or, the wireless radio is a wireless radio based on the 5th generation mobile communication network technology (5G) standard. For example, the wireless radio is a new radio. Or, the wireless radio may also be a wireless radio based on the next generation mobile communication network technology standard of the 5G.

In some embodiments, an end to end (E2E) connection may also be established between UEs 110, for example, a vehicle to vehicle (V2V) communication, a vehicle to infrastructure (V2I) communication and a vehicle to pedestrian (V2P) communication in a vehicle to everything (V2X) communication.

Here, the UE can be considered as the terminal device of the following embodiments.

In some embodiments, and as shown in FIG. 1, the wireless communication system may further include a network management device 130.

Several base stations 120 are connected to the network management device 130, respectively. The network management device 130 may be an access and mobility management function (AMF), a session management function (SMF), a user plane function (UPF), a policy control function (PCF), a network repository function (NRF), etc. The implementation form of the network management device 130 is not limited in the embodiments of the present disclosure.

In order to facilitate those skilled in the art to understand, the embodiments of the present disclosure enumerate implementation manners to clearly illustrate the technical solutions of the embodiments of the present disclosure. Of course, those skilled in the art can understand that the embodiments provided in the present disclosure can be executed independently, or can be combined with the methods of other embodiments of the present disclosure to be executed together, or can be executed together with some methods in other related technologies after being executed alone or being combined, which is limited in the embodiments of the present disclosure.

In order to better understand the technical solution described in any embodiment of the present disclosure, firstly, application scenarios in related technologies are described.

Extended reality (XR) services such as cloud augmented reality (AR) or virtual reality (VR), cloud games, remote control of machines or drones based on video, and the like are expected to contribute more and more traffic to 5G networks.

In addition to audio and video flows, XR services also involve multi-modal data flows, for example, bio-tactile sensing data flows. The multi-modal data is data that describes the same service or application is input from the same device or different devices (including sensors), and the data may be output to one or more destination device terminals. Respective data flows in the multi-modal data generally have a certain or even strong correlation, for example, synchronization of audio and video flows, tactile and visual synchronization, etc. There are some common characteristics in data flows of this type of media services, among the data flows, and requirements of these service data flows for network transmission. The effective identification and utilization of these characteristics will be more conducive to the transmission and control of networks and services, as well as to service guarantee and user experience.

However, the 5 GS system adopts a general QoS mechanism to handle various data services including XR services, without fully considering the characteristics of XR media services, and cannot effectively support differentiated uplink and downlink requirements, for example, asymmetric requirements for uplink data reliability and downlink data bandwidth. Meanwhile, XR media data flows have characteristics of high bandwidth, low latency, and high reliability requirements, resulting in significant energy consumption. The energy consumption scheme is also an important factor affecting service usage and user experience.

In some embodiments, based on the existing UE implementation, multiple schemes can be applied locally to the UE according to the battery level. For example, when the battery level exceeds 80%, a high screen refresh rate can be maintained for all services. When the battery level is below 80%, a medium screen refresh rate can be maintained for all services. When the battery level is below 20%, some non-mandatory and high-power threads or applications can be closed. When the battery level is below 10%, all non-mandatory or high-power threads or applications can be closed or prohibited. However, it has never been considered to lower QoS levels for certain specific services when the battery power is insufficient.

In some embodiments, “UE battery level change” is defined as access-related policy control request trigger and/or a non-access-related policy control request trigger. A policy control function (PCF) subscribes to an access and mobility management function (AMF) or a session management function (SMF) when the UE battery level changes. When receiving a “change UE battery level” event, the PCF determines a policy according to the current UE battery level, for example, selecting a QoS level corresponding to a low or ultra-low battery level for service.

In an embodiment, an objective is defined for XR and media services related to terminal power management: to consider traffic patterns of media services and study a potential enhancement function of power management. Power saving enhancement, for example, supporting a trade-off of throughput, latency, reliability, considering device battery life, whether and how to enhance CDRX, considering XR or media traffic pattern. A more efficient codec requires more power consumption and higher reliability. In addition, higher throughput and lower latency budget also require more power consumption and more network resources. Hence, a trade-off of QoE and device power consumption needs to be considered. There is no corresponding QoS and policy mechanism for how to support the trade-off between throughput/latency/reliability and power consumption (for example, device battery life). In particular, in order to support XR media services and transmission of multi-modal data flows, the potential enhancement of energy management considering traffic characteristics of the XR media services is studied. For example, the trade-off of throughput, latency, reliability, and other factors considering device (UE) status information is supported. The 5 GS system does not support this type of requirements yet, and there is no corresponding technical solution.

As shown in FIG. 2, this embodiment provides a wireless communication method. The method is performed by a base station and includes steps 21 and 22.

In step 21, terminal status information (UE status information) is obtained from a first network function, where the UE status information indicates terminal status (UE status).

In step 22, a QoS specification for a first service is updated according to the UE status information.

The base station involved in the present disclosure can be of various types, for example, a base station of the third generation mobile communication (3G) network, a base station of the fourth generation mobile communication (4G) network, a base station of the fifth generation mobile communication (5G) network, or other evolved base station.

The network function involved in the present disclosure can be a device in a core network, for example, the first network function is an SMF.

The terminal involved in the present disclosure may be, but is not limited to, a mobile phone, a wearable device, a vehicle-mounted terminal, a road side unit (RSU), a smart home terminal, an industrial sensing device, and/or a medical device. In some embodiments, the terminal may be a Redcap terminal or a predetermined version of a new radio (NR) terminal (for example, a R17 NR terminal).

However, it should be noted that this embodiment is not limited to being performed by a terminal, and can also be performed by a base station or other network communication nodes in a core network in specific scenarios, which is not limited herein. For example, in scenarios where the base station serves as a receiver and/or a transmitter in a multi-modal service, this embodiment can also be performed by the base station. In scenarios where a core network device serves as the receiver and/or the transmitter in the multi-modal service, this embodiment can also be performed by the core network device. It should be noted that the schematic representation of the terminal as an execution subject in the present disclosure does not limit the technical solution in the present disclosure.

It should be noted that for the selection of an alternative QoS, different QoS levels correspond to different QoS specifications. In some scenarios, a QoS specification in the present disclosure can be understood as a QoS level.

In an embodiment, the first service includes at least one of the following: an extended reality and media (XRM) service; or a multi-modal service.

However, it should be noted that the first service is not limited to the XRM service and/or the multi-modal service, and can also be various general services or basic services, for example, terminal services, etc., which is not limited herein.

In an embodiment, the UE status information is information associated with terminal (UE) power supply.

In an embodiment, the UE status information includes at least one of the following: information on a battery level; information on a battery life; information on a powered mode, for example, the information on the powered mode can be information on a battery-powered mode and a wall-powered mode; information on a degree of heat generation, for example, the information on the degree of heat generation can be information on low heat status, medium heat status, and overheating status, etc.; or information on a central processing unit (CPU) load.

In an embodiment, the UE status information is obtained from the first network function, where the UE status information indicates the UE status; and the QoS specification is updated according to the UE status information and a mapping relationship between UE status and QoSs.

For example, the mapping relationship between the UE status and the QoSs can be a mapping relationship between the UE status and QoS specifications. As shown in Table 1, the mapping relationship between the UE status and QoS specifications is shown.

TABLE 1

| UE Status | QoS level |
|---|---|
| good (high battery level, best working temperature, and/or | high |
| low CPU load) | |
| normal (normal battery level, normal working temperature, | normal |
| and/or medium CPU load) | |
| bad (low battery level, overheating, and/or high CPU load) | low |

In an embodiment, the mapping relationship is indicated by one of the following information: indication information issued by a policy control function (PCF); QoS profile indication information; or operator policies indication information.

In an embodiment, in response to receiving the UE status information, the QoS specification for the first service is updated according to the UE status information. Or, in response to receiving the UE status information and a number of predetermined resources being less than a number threshold (for example, available radio resources become limited), the QoS specification for the first service is updated according to the UE status information. Or, in response to receiving the UE status information and a number of required predetermined resources greater than a number threshold (for example, when there are more required wireless resources), the QoS specification for the first service is updated according to the UE status information.

In an embodiment, the UE status information is obtained from the first network function, where the UE status information indicates the UE status. The QoS specification is updated according to the UE status information and indication information on terminal status management (UE status management).

In an embodiment, the UE status information is obtained from the first network function, where the UE status information indicates the UE status. The QoS specification for the first service is updated according to the UE status information. Information on an updated QoS specification and/or current UE status information of the UE are sent to a predetermined object. The predetermined object includes at least one of the following: a network function of a core network; a terminal; or an application function (AF).

In an embodiment, the UE status information is obtained from the first network function, where the UE status information indicates the UE status. The QoS specification for the first service is updated according to the UE status information. In response to the QoS specification for the first service being updated, the information on the updated QoS specification and/or the current UE status information of the UE are sent to the predetermined object.

In an embodiment, the UE status information is obtained from the first network function, where the UE status information indicates the UE status. The QoS specification for the first service is updated according to the UE status information. In a packet data unit (PDU) session modification procedure, the information on the updated QoS specification and/or the current UE status information of the UE are sent to the predetermined object.

In an embodiment, the UE status information is obtained from the first network function, where the UE status information indicates the UE status. The QoS specification for the first service is updated according to the UE status information. In response to notification control being configured for a guaranteed bit rate (GBR) QoS flow and a target QoS specification of the QoS flow cannot be fulfilled, the information on the updated QoS specification and/or the current UE status information of the UE are sent to the first network function.

In an embodiment, the UE status information is obtained from the first network function, where the UE status information indicates the UE status. The QoS specification for the first service is updated according to the UE status information. In response to the notification control being configured for the GBR QoS flow, and the target QoS specification of the QoS flow being fulfilled again after the QoS specification is adjusted based on a result that the target QoS specification of the QoS flow cannot be fulfilled, the information on the updated QoS specification and/or the current UE status information of the UE are sent to the first network function.

In an embodiment, the UE status information is obtained from the first network function, where the UE status information indicates the UE status. The QoS specification for the first service is updated according to the UE status information. The information on the updated QoS specification and/or the current UE status information of the UE are sent to the first network function through a N2 message. The N2 message indicates a reference to an alternative QoS profile and/or the UE status information, where the alternative QoS profile matches values of one or more currently fulfilled QoS parameters.

In the embodiment of the present disclosure, the UE status information is obtained from the first network function, where the UE status information indicates the UE status. According to the UE state information, the QoS specification is updated based on information on an alternative QoS parameter set. The information on the alternative QoS parameter set includes at least one of the following: alternative QoS parameters for a GBR data flow, where the alternative QoS parameters include an averaging window and a maximum data burst volume; or indication information on UE status management.

In an embodiment, the UE status information is obtained from the first network function, where the UE status information indicates the UE status. The QoS specification for the first service is updated according to the UE status information. Herein, after obtaining the UE status information from the first network function, the base station can update the QoS specification for the first service based on the UE status indicated by the UE status information. Compared to always setting a fixed QoS specification for the first service, the QoS specification can be adapted to the UE status, and a balance between experience quality and device power consumption can be achieved.

It should be noted that those skilled in the art can understand that the method provided in the embodiment of the present disclosure can be executed separately or together with some methods in the embodiments of the present disclosure or related technologies.

As shown in FIG. 3, this embodiment provides a wireless communication method. The method is performed by a base station and includes step 31.

In step 31, a QoS specification is updated according to UE status information and a mapping relationship between UE status and QoSs; or the QoS specification is updated according to the UE status information and indication information on UE status management.

In an embodiment, the UE status information is obtained from a first network function, where the UE status information indicates UE status. The QoS specification is updated according to the UE status information and the mapping relationship between the UE status and the QoSs.

For example, the mapping relationship between the UE status and the QoSs can be a mapping relationship between the UE status and QoS specifications.

In an embodiment, the mapping relationship is indicated by one of the following information: QoS profile indication information; or operator policies indication information.

In an embodiment, the UE status information is obtained from the first network function, where the UE status information indicates the UE status. The QoS specification is updated according to the UE status information and indication information on UE status management.

It should be noted that those skilled in the art can understand that the method provided in the embodiment of the present disclosure can be executed separately or together with some methods in the embodiments of the present disclosure or related technologies.

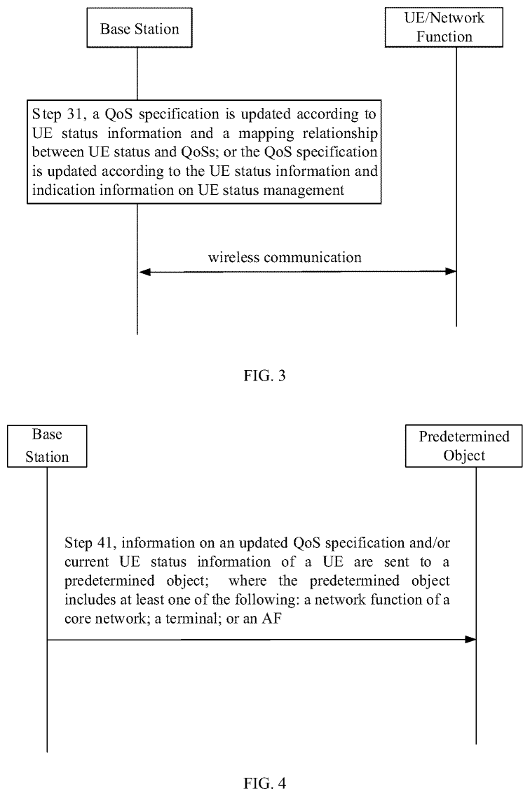

As shown in FIG. 4, this embodiment provides a wireless communication method. The method is performed by a base station and includes step 41.

In step 41, information on an updated QoS specification and/or current UE status information of a UE are sent to a predetermined object. Where the predetermined object includes at least one of the following: a network function of a core network; a terminal; or an application function (AF).

In an embodiment, the UE status information is obtained from a first network function, where the UE status information indicates UE status. The QoS specification for a first service is updated according to the UE status information. Information on an updated QoS specification and/or current UE status information of the UE are sent to a predetermined object. The predetermined object includes at least one of the following: a network function of a core network; a terminal; or an AF.

In an embodiment, the UE status information is obtained from the first network function, where the UE status information indicates the UE status. The QoS specification for the first service is updated according to the UE status information. In response to the QoS specification for the first service being updated, the information on the updated QoS specification and/or the current UE status information of the UE are sent to the predetermined object.

In an embodiment, the UE status information is obtained from the first network function, where the UE status information indicates the UE status. The QoS specification for the first service is updated according to the UE status information. In a packet data unit (PDU) session modification procedure, the information on the updated QoS specification and/or the current UE status information of the UE are sent to the predetermined object.

In an embodiment, the UE status information is obtained from the first network function, where the UE status information indicates the UE status. The QoS specification for the first service is updated according to the UE status information. In response to notification control being configured for a GBR QoS flow and a target QoS specification of the QoS flow cannot be fulfilled, the information on the updated QoS specification and/or the current UE status information of the UE are sent to the first network function.

In an embodiment, the UE status information is obtained from the first network function, where the UE status information indicates the UE status. The QoS specification for the first service is updated according to the UE status information. In response to the notification control being configured for the GBR QoS flow, and the target QoS specification of the QoS flow being fulfilled again after the QoS specification is adjusted based on a result that the target QoS specification of the QoS flow cannot be fulfilled, the information on the updated QoS specification and/or the current UE status information of the UE are sent to the first network function.

In an embodiment, the UE status information is obtained from the first network function, where the UE status information indicates the UE status. The QoS specification for the first service is updated according to the UE status information. The information on the updated QoS specification and/or the current UE status information of the UE are sent to the first network function through a N2 message. The N2 message indicates a reference to an alternative QoS profile and/or the UE status information, where the alternative QoS profile matches values of one or more currently fulfilled QoS parameters.

It should be noted that those skilled in the art can understand that the method provided in the embodiment of the present disclosure can be executed separately or together with some methods in the embodiments of the present disclosure or related technologies.

As shown in FIG. 5, this embodiment provides a wireless communication method. The method is performed by a base station and includes step 51.

In step 51, a QoS specification is updated based on information on an alternative QoS parameter set. Where information on the alternative QoS parameter set includes at least one of the following: alternative QoS parameters for a GBR data flow, where the alternative QoS parameters include an averaging window and a maximum data burst volume; or indication information on UE status management.

In an embodiment, the UE status information is obtained from a first network function, where the UE status information indicates the UE status. According to the UE state information, the QoS specification is updated based on information on an alternative QoS parameter set. The information on the alternative QoS parameter set includes at least one of the following: alternative QoS parameters for a GBR data flow, where the alternative QoS parameters include an averaging window and a maximum data burst volume; or indication information on UE status management.

It should be noted that those skilled in the art can understand that the method provided in the embodiment of the present disclosure can be executed separately or together with some methods in the embodiments of the present disclosure or related technologies.

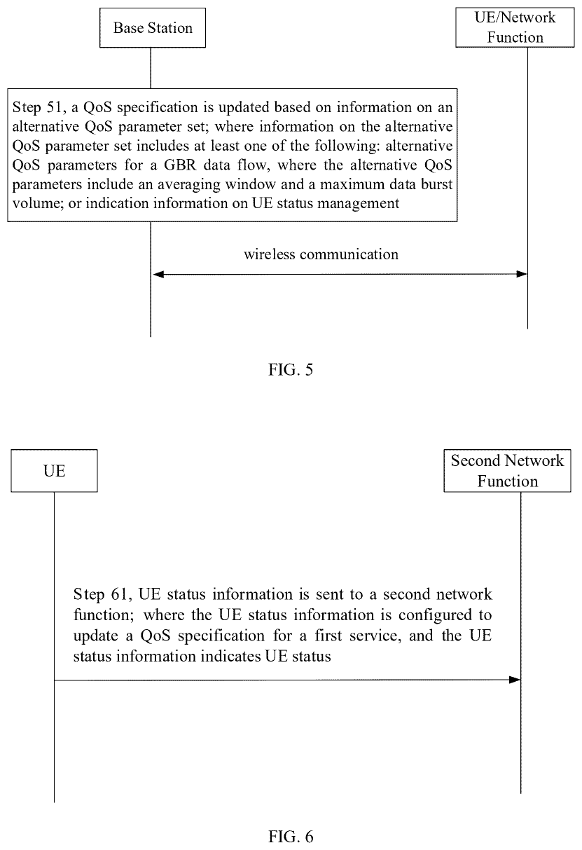

As shown in FIG. 6, this embodiment provides a wireless communication method. The method is performed by a UE and includes step 61.

In step 61, UE status information is sent to a second network function; where the UE status information is configured to update a QoS specification for a first service, and the UE status information indicates UE status.

The base station involved in the present disclosure can be of various types, for example, a base station of the third generation mobile communication (3G) network, a base station of the fourth generation mobile communication (4G) network, a base station of the fifth generation mobile communication (5G) network, or other evolved base station.

The network function involved in the present disclosure can be a device in a core network, for example, the second network function is an AMF.

The terminal involved in the present disclosure may be, but is not limited to, a mobile phone, a wearable device, a vehicle-mounted terminal, a road side unit (RSU), a smart home terminal, an industrial sensing device, and/or a medical device. In some embodiments, the terminal may be a Redcap terminal or a predetermined version of a new radio (NR) terminal (for example, a R17 NR terminal).

In an embodiment, the UE status information is obtained; the UE status information is sent to the second network function. The UE status information is configured to update the QoS specification for the first service, and the UE status information indicates the UE status.

In an embodiment, the first service includes at least one of the following: an extended reality and media (XRM) service; or a multi-modal service.

However, it should be noted that the first service is not limited to the XRM service and/or the multi-modal service, and can also be various general services or basic services, for example, terminal services, etc., which is not limited herein.

In an embodiment, the UE status information is information associated with terminal (UE) power supply.

In an embodiment, the UE status information includes at least one of the following: information on a battery level; information on a battery life; information on a powered mode, for example, the information on the powered mode can be information on a battery-powered mode and a wall-powered mode; information on a degree of heat generation, for example, the information on the degree of heat generation can be information on low heat status, medium heat status, and overheating status, etc.; or information on a central processing unit (CPU) load.

In an embodiment, the UE status information is obtained; in a packet data unit (PDU) session establishment procedure, the UE status information is sent to the second network function through a protocol configuration option (PCO) of a PDU session establishment request. The UE status information is configured to update the QoS specification for the first service, and the UE status information indicates the UE status.

In an embodiment, the UE status information is obtained; in the PDU session establishment procedure, the UE status information is sent to the second network function through a session management core network capability (for example, 5 GSM core network capability) of the PDU session establishment request. The UE status information is configured to update the QoS specification for the first service, and the UE status information indicates the UE status.

In an embodiment, information on an updated QoS specification and/or current UE status information of the UE sent by the base station are received.

It should be noted that those skilled in the art can understand that the method provided in the embodiment of the present disclosure can be executed separately or together with some methods in the embodiments of the present disclosure or related technologies.

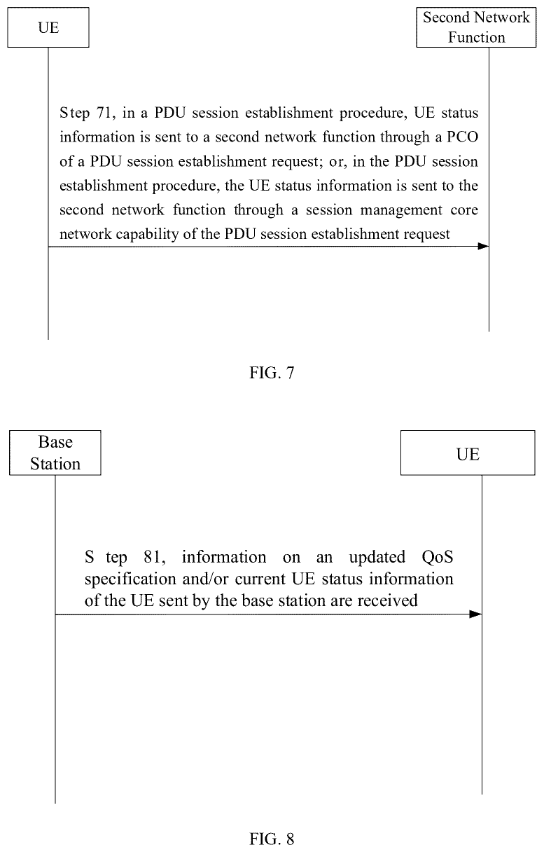

As shown in FIG. 7, this embodiment provides a wireless communication method. The method is performed by a UE and includes step 71.

In step 71, in a packet data unit (PDU) session establishment procedure, UE status information is sent to a second network function through a protocol configuration option (PCO) of a PDU session establishment request; or, in the PDU session establishment procedure, the UE status information is sent to the second network function through a session management core network capability of the PDU session establishment request.

In an embodiment, the UE status information is obtained; in a PDU session establishment procedure, the UE status information is sent to the second network function through the PCO of the PDU session establishment request. The UE status information is configured to update a QoS specification for a first service, and the UE status information indicates UE status.

In an embodiment, the UE status information is obtained; in the PDU session establishment procedure, the UE status information is sent to the second network function through the session management core network capability of the PDU session establishment request. The UE status information is configured to update the QoS specification for the first service, and the UE status information indicates the UE status.

It should be noted that those skilled in the art can understand that the method provided in the embodiment of the present disclosure can be executed separately or together with some methods in the embodiments of the present disclosure or related technologies.

As shown in FIG. 8, this embodiment provides a wireless communication method. The method is performed by a UE and includes step 81.

In step 81, information on an updated QoS specification and/or current UE status information of a UE sent by a base station are received.

In an embodiment, the UE status information includes at least one of the following: information on a battery level; information on a battery life; information on a powered mode; information on a degree of heat generation; or information on a central processing unit (CPU) load.

It should be noted that those skilled in the art can understand that the method provided in the embodiment of the present disclosure can be executed separately or together with some methods in the embodiments of the present disclosure or related technologies.

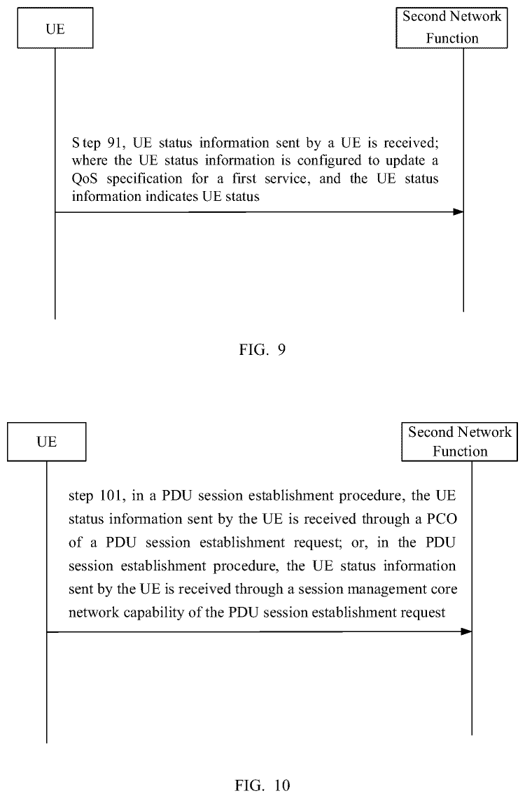

As shown in FIG. 9, this embodiment provides a wireless communication method. The method is performed by a second network function and includes step 91.

In step 91, UE status information sent by a UE is received; where the UE status information is configured to update a QoS specification for a first service, and the UE status information indicates UE status.

The base station involved in the present disclosure can be of various types, for example, a base station of the third generation mobile communication (3G) network, a base station of the fourth generation mobile communication (4G) network, a base station of the fifth generation mobile communication (5G) network, or other evolved base station.

The network function involved in the present disclosure can be a device in a core network, for example, the first network function is an SMF; the second network function is an AMF.

The terminal involved in the present disclosure may be, but is not limited to, a mobile phone, a wearable device, a vehicle-mounted terminal, a road side unit (RSU), a smart home terminal, an industrial sensing device, and/or a medical device. In some embodiments, the terminal may be a Redcap terminal or a predetermined version of a new radio (NR) terminal (for example, a R17 NR terminal).

In an embodiment, the first service includes at least one of the following: an extended reality and media (XRM) service; or a multi-modal service.

However, it should be noted that the first service is not limited to the XRM service and/or the multi-modal service, and can also be various general services or basic services, for example, terminal services, etc., which is not limited herein.

In an embodiment, the UE status information is information associated with terminal (UE) power supply.

In an embodiment, the UE status information includes at least one of the following: information on a battery level; information on a battery life; information on a powered mode, for example, the information on the powered mode can be information on a battery-powered mode and a wall-powered mode; information on a degree of heat generation, for example, the information on the degree of heat generation can be information on low heat status, medium heat status, and overheating status, etc.; or information on a central processing unit (CPU) load.

In an embodiment, in a PDU session establishment procedure, the UE status information sent by the UE is received through a protocol configuration option (PCO) of a PDU session establishment request. The UE status information is configured to update the QoS specification for the first service, and the UE status information indicates the UE status.

In an embodiment, in the PDU session establishment procedure, the UE status information sent by the UE is received through a session management core network capability of the PDU session establishment request. The UE status information is configured to update the QoS specification for the first service, and the UE status information indicates the UE status.

In an embodiment, the UE status information sent by the UE is received. The UE status information is configured to update the QoS specification for the first service, and the UE status information indicates the UE status. The first network function is determined. The UE status information is sent to the first network function.

In an embodiment, the UE status information sent by the UE is received. The UE status information is configured to update the QoS specification for the first service, and the UE status information indicates the UE status. The first network function is determined. In a PDU session establishment procedure, the UE status information sent to the first network function through a protocol configuration option (PCO) for creating a session management (SM) context request.

In an embodiment, the UE status information sent by the UE is received. The UE status information is configured to update the QoS specification for the first service, and the UE status information indicates the UE status. The first network function is determined. In the PDU session establishment procedure, the UE status information is sent to the first network function through a session management core network capability for creating the SM context request.

In an embodiment, information on an updated QoS specification and/or current UE status information of the UE sent by the base station are received.

It should be noted that those skilled in the art can understand that the method provided in the embodiment of the present disclosure can be executed separately or together with some methods in the embodiments of the present disclosure or related technologies.

As shown in FIG. 10, this embodiment provides a wireless communication method. The method is performed by a second network function and includes step 101.

In step 101, in a PDU session establishment procedure, the UE status information sent by the UE is received through a protocol configuration option (PCO) of a PDU session establishment request; or, in the PDU session establishment procedure, the UE status information sent by the UE is received through a session management core network capability of the PDU session establishment request.

In an embodiment, in the PDU session establishment procedure, the UE status information sent by the UE is received through the PCO of the PDU session establishment request. The UE status information is configured to update a QoS specification for a first service, and the UE status information indicates UE status.

In an embodiment, in the PDU session establishment procedure, the UE status information sent by the UE is received through the session management core network capability of the PDU session establishment request. The UE status information is configured to update the QoS specification for the first service, and the UE status information indicates the UE status.

It should be noted that those skilled in the art can understand that the method provided in the embodiment of the present disclosure can be executed separately or together with some methods in the embodiments of the present disclosure or related technologies.

As shown in FIG. 11, this embodiment provides a wireless communication method. The method is performed by a second network function and includes steps 111 and 112.

In step 111, a first network function is determined.

In step 112, UE status information is sent to the first network function.

In an embodiment, the UE status information sent by the UE is received. The UE status information is configured to update a QoS specification for a first service, and the UE status information indicates UE status. The first network function is determined. The UE status information is sent to the first network function.

In an embodiment, the UE status information sent by the UE is received. The UE status information is configured to update the QoS specification for the first service, and the UE status information indicates the UE status. The first network function is determined. In a PDU session establishment procedure, the UE status information sent to the first network function through a protocol configuration option (PCO) for creating a session management (SM) context request.

In an embodiment, the UE status information sent by the UE is received. The UE status information is configured to update the QoS specification for the first service, and the UE status information indicates the UE status. The first network function is determined. In the PDU session establishment procedure, the UE status information is sent to the first network function through a session management core network capability for creating the SM context request.

It should be noted that those skilled in the art can understand that the method provided in the embodiment of the present disclosure can be executed separately or together with some methods in the embodiments of the present disclosure or related technologies.

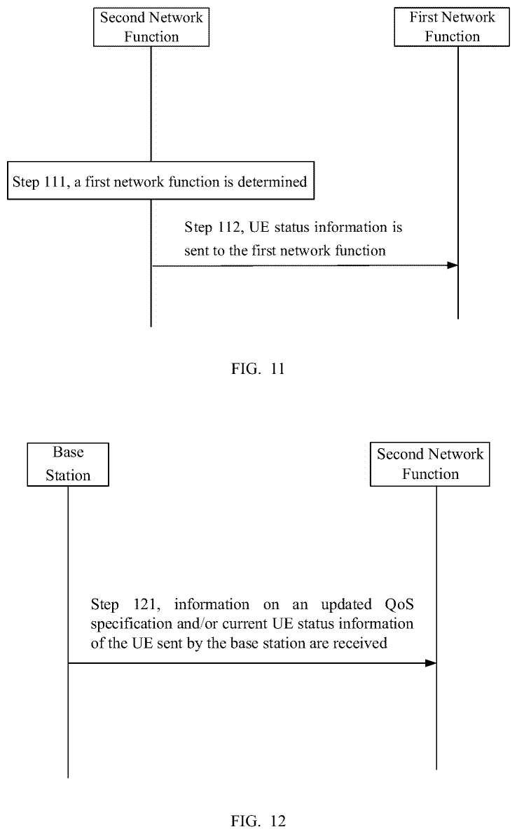

As shown in FIG. 12, this embodiment provides a wireless communication method. The method is performed by a second network function and includes step 121.

In step 121, information on an updated QoS specification and/or current UE status information of a UE sent by a base station are received.

The UE status information includes at least one of the following: information on a battery level; information on a battery life; information on a powered mode; information on a degree of heat generation; or information on a central processing unit (CPU) load.

It should be noted that those skilled in the art can understand that the method provided in the embodiment of the present disclosure can be executed separately or together with some methods in the embodiments of the present disclosure or related technologies.

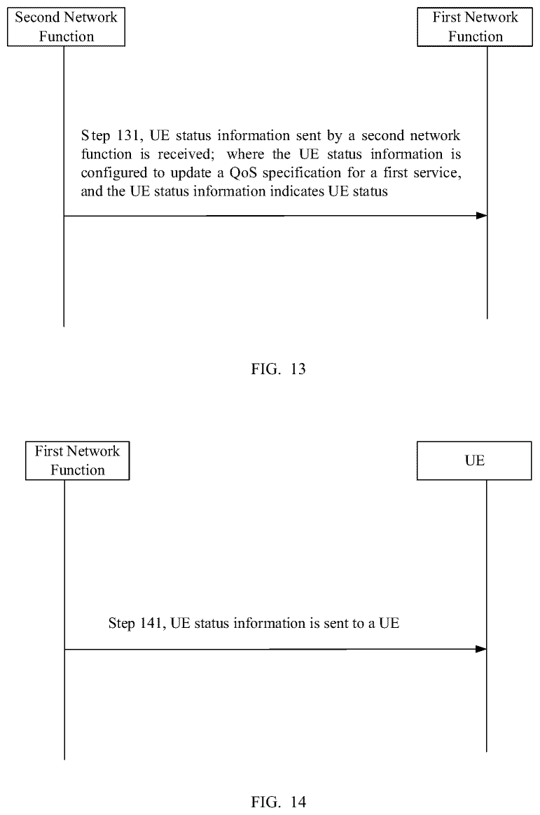

As shown in FIG. 13, this embodiment provides a wireless communication method. The method is performed by a first network function and includes step 131.

In step 131, UE status information sent by a second network function is received; where the UE status information is configured to update a QoS specification for a first service, and the UE status information indicates UE status.

The base station involved in the present disclosure can be of various types, for example, a base station of the third generation mobile communication (3G) network, a base station of the fourth generation mobile communication (4G) network, a base station of the fifth generation mobile communication (5G) network, or other evolved base station.

The network function involved in the present disclosure can be a device in a core network, for example, the first network function is an SMF; the second network function is an AMF.

The terminal involved in the present disclosure may be, but is not limited to, a mobile phone, a wearable device, a vehicle-mounted terminal, a road side unit (RSU), a smart home terminal, an industrial sensing device, and/or a medical device. In some embodiments, the terminal may be a Redcap terminal or a predetermined version of a new radio (NR) terminal (for example, a R17 NR terminal).

In an embodiment, the first service includes at least one of the following: an extended reality and media (XRM) service; or a multi-modal service.

However, it should be noted that the first service is not limited to the XRM service and/or the multi-modal service, and can also be various general services or basic services, for example, terminal services, etc., which is not limited herein.

In an embodiment, the UE status information is information associated with terminal (UE) power supply.

In an embodiment, the UE status information includes at least one of the following: information on a battery level; information on a battery life; information on a powered mode, for example, the information on the powered mode can be information on a battery-powered mode and a wall-powered mode; information on a degree of heat generation, for example, the information on the degree of heat generation can be information on low heat status, medium heat status, and overheating status, etc.; or information on a central processing unit (CPU) load.

In an embodiment, the UE status information sent by the second network function is received; where the UE status information is configured to update the QoS specification for the first service, and the UE status information indicates the UE status. The UE status information is sent to the UE.

In an embodiment, in a PDU session establishment procedure, the UE status information sent by the second network function is received through a protocol configuration option (PCO) for creating a session management (SM) context request. The UE status information is configured to update the QoS specification for the first service, and the UE status information indicates the UE status.

In an embodiment, in the PDU session establishment procedure, the UE status information sent by the second network function is received through a session management core network capability for creating the SM context request. The UE status information is configured to update the QoS specification for the first service, and the UE status information indicates the UE status.

In an embodiment, the UE status information sent by the second network function is received; where the UE status information is configured to update the QoS specification for the first service, and the UE status information indicates the UE status. Whether to create a PDU session is determined based on subscription data, event request information, and/or local policies associated with the UE status information.

In an embodiment, the UE status information sent by the second network function is received; where the UE status information is configured to update the QoS specification for the first service, and the UE status information indicates the UE status. Whether the UE status information satisfies predetermined requirements is determined; and in response to the UE status information satisfying the predetermined requirements, PDU session creation of the first service is rejected, or the PDU session creation is received and the first service is not supported.

In an embodiment, the UE status information sent by the second network function is received; where the UE status information is configured to update the QoS specification for the first service, and the UE status information indicates the UE status. Whether to report request events associated with the UE status information is determined based on the subscription data, the event request information, and/or the local policies associated with the UE status information.

In an embodiment, the UE status information sent by the second network function is received; where the UE status information is configured to update the QoS specification for the first service, and the UE status information indicates the UE status. Whether to report request events associated with the UE status information is determined based on the subscription data, the event request information, and/or the local policies associated with the UE status information. The UE status information is sent to a third network function based on a request sent by the third network function.

In an embodiment, the UE status information sent by the second network function is received; where the UE status information is configured to update the QoS specification for the first service, and the UE status information indicates the UE status. Whether to report request events associated with the UE status information is determined based on the subscription data, the event request information, and/or the local policies associated with the UE status information. The UE status information is sent to the third network function based on the subscription data and/or operator policies.

In an embodiment, the UE status information sent by the second network function is received; where the UE status information is configured to update the QoS specification for the first service, and the UE status information indicates the UE status. Whether to perform a local policies and QoS authorization is determined based on the subscription data, the event request information, and/or the local policies associated with the UE status information.

In an embodiment, information on an updated QoS specification and/or current UE status information of the UE sent by the base station are received.

It should be noted that those skilled in the art can understand that the method provided in the embodiment of the present disclosure can be executed separately or together with some methods in the embodiments of the present disclosure or related technologies.

As shown in FIG. 14, this embodiment provides a wireless communication method. The method is performed by a first network function and includes step 141.

In step 141, UE status information is sent to a UE.

In an embodiment, the UE status information includes at least one of the following: information on a battery level; information on a battery life; information on a powered mode, for example, the information on the powered mode can be information on a battery-powered mode and a wall-powered mode; information on a degree of heat generation, for example, the information on the degree of heat generation can be information on low heat status, medium heat status, and overheating status, etc.; or information on a central processing unit (CPU) load.

In an embodiment, the UE status information sent by a second network function is received; where the UE status information is configured to update a QoS specification for a first service, and the UE status information indicates UE status. The UE status information is sent to the UE.

It should be noted that those skilled in the art can understand that the method provided in the embodiment of the present disclosure can be executed separately or together with some methods in the embodiments of the present disclosure or related technologies.

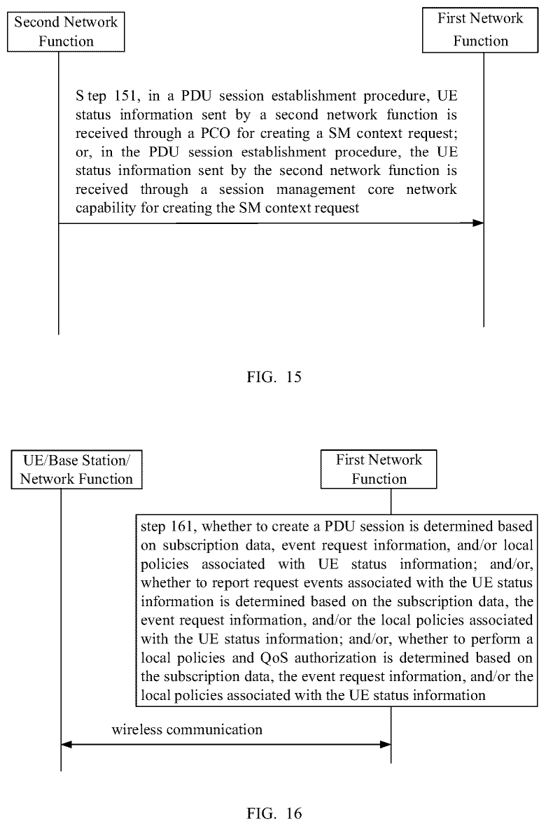

As shown in FIG. 15, this embodiment provides a wireless communication method. The method is performed by a first network function and includes step 151.

In step 151, in a PDU session establishment procedure, UE status information sent by a second network function is received through a protocol configuration option (PCO) for creating a session management (SM) context request; or, in the PDU session establishment procedure, the UE status information sent by the second network function is received through a session management core network capability for creating the SM context request.

In an embodiment, in the PDU session establishment procedure, the UE status information sent by the second network function is received through the PCO for creating the SM context request. The UE status information is configured to update the QoS specification for the first service, and the UE status information indicates the UE status.

In an embodiment, in the PDU session establishment procedure, the UE status information sent by the second network function is received through the session management core network capability for creating the SM context request. The UE status information is configured to update the QoS specification for the first service, and the UE status information indicates the UE status.

It should be noted that those skilled in the art can understand that the method provided in the embodiment of the present disclosure can be executed separately or together with some methods in the embodiments of the present disclosure or related technologies.

As shown in FIG. 16, this embodiment provides a wireless communication method. The method is performed by a first network function and includes step 161.

In step 161, whether to create a PDU session is determined based on subscription data, event request information, and/or local policies associated with UE status information; and/or, whether to report request events associated with the UE status information is determined based on the subscription data, the event request information, and/or the local policies associated with the UE status information; and/or, whether to perform a local policies and QoS authorization is determined based on the subscription data, the event request information, and/or the local policies associated with the UE status information.

In an embodiment, the UE status information sent by a second network function is received; where the UE status information is configured to update a QoS specification for a first service, and the UE status information indicates UE status. Whether to create the PDU session is determined based on the subscription data, the event request information, and/or the local policies associated with the UE status information.

In an embodiment, the UE status information sent by the second network function is received; where the UE status information is configured to update the QoS specification for the first service, and the UE status information indicates the UE status. Whether the UE status information satisfies predetermined requirements is determined; and in response to the UE status information satisfying the predetermined requirements, PDU session creation of the first service is rejected, or the PDU session creation is received and the first service is not supported.

In an embodiment, the UE status information sent by the second network function is received; where the UE status information is configured to update the QoS specification for the first service, and the UE status information indicates the UE status. Whether to report request events associated with the UE status information is determined based on the subscription data, the event request information, and/or the local policies associated with the UE status information.

In an embodiment, the UE status information sent by the second network function is received; where the UE status information is configured to update the QoS specification for the first service, and the UE status information indicates the UE status. Whether to report request events associated with the UE status information is determined based on the subscription data, the event request information, and/or the local policies associated with the UE status information. The UE status information is sent to a third network function based on a request sent by the third network function.

In an embodiment, the UE status information sent by the second network function is received; where the UE status information is configured to update the QoS specification for the first service, and the UE status information indicates the UE status. Whether to report request events associated with the UE status information is determined based on the subscription data, the event request information, and/or the local policies associated with the UE status information. The UE status information is sent to the third network function based on the subscription data and/or operator policies.

In an embodiment, the UE status information sent by the second network function is received; where the UE status information is configured to update the QoS specification for the first service, and the UE status information indicates the UE status. Whether to perform a local policies and QoS authorization is determined based on the subscription data, the event request information, and/or the local policies associated with the UE status information.

In an embodiment, information on an updated QoS specification and/or current UE status information of the UE sent by a base station are received.

It should be noted that those skilled in the art can understand that the method provided in the embodiment of the present disclosure can be executed separately or together with some methods in the embodiments of the present disclosure or related technologies.

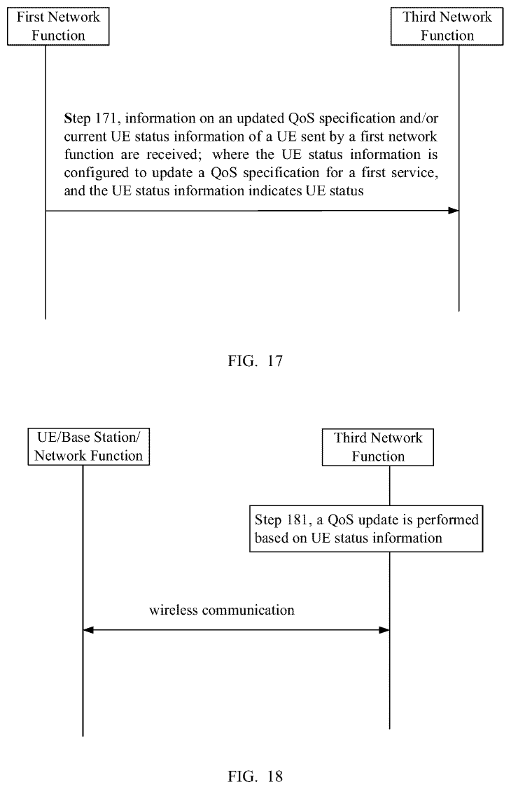

As shown in FIG. 17, this embodiment provides a wireless communication method. The method is performed by a third network function and includes step 171.

In step 171, information on an updated QoS specification and/or current UE status information of a UE sent by a first network function are received; where the UE status information is configured to update a QoS specification for a first service, and the UE status information indicates UE status.

The base station involved in the present disclosure can be of various types, for example, a base station of the third generation mobile communication (3G) network, a base station of the fourth generation mobile communication (4G) network, a base station of the fifth generation mobile communication (5G) network, or other evolved base station.

The network function involved in the present disclosure can be a device in a core network, for example, the third network function is a PCF.

The terminal involved in the present disclosure may be, but is not limited to, a mobile phone, a wearable device, a vehicle-mounted terminal, a road side unit (RSU), a smart home terminal, an industrial sensing device, and/or a medical device. In some embodiments, the terminal may be a Redcap terminal or a predetermined version of a new radio (NR) terminal (for example, a R17 NR terminal).

In an embodiment, the first service includes at least one of the following: an extended reality and media (XRM) service; or a multi-modal service.

However, it should be noted that the first service is not limited to the XRM service and/or the multi-modal service, and can also be various general services or basic services, for example, terminal services, etc., which is not limited herein.

In an embodiment, the UE status information is information associated with terminal (UE) power supply.

In an embodiment, the UE status information includes at least one of the following: information on a battery level; information on a battery life; information on a powered mode, for example, the information on the powered mode can be information on a battery-powered mode and a wall-powered mode; information on a degree of heat generation, for example, the information on the degree of heat generation can be information on low heat status, medium heat status, and overheating status, etc.; or information on a central processing unit (CPU) load.

In an embodiment, the information on the updated QoS specification and/or the current UE status information of the UE sent by the first network function are received; where the UE status information is configured to update the QoS specification for the first service, and the UE status information indicates the UE status. A QoS update is performed based on the UE status information.

In an embodiment, the information on the updated QoS specification and/or the current UE status information of the UE sent by the first network function are received; where the UE status information is configured to update the QoS specification for the first service, and the UE status information indicates the UE status. The QoS update is performed based on the UE status information. In a session management creation or modification procedure, policy information associated with an updated QoS is sent to the first network function.

It should be noted that those skilled in the art can understand that the method provided in the embodiment of the present disclosure can be executed separately or together with some methods in the embodiments of the present disclosure or related technologies.

As shown in FIG. 18, this embodiment provides a wireless communication method. The method is performed by a third network function and includes step 181.

In step 181, a QoS update is performed based on UE status information.

In an embodiment, information on an updated QoS specification and/or current UE status information of a UE sent by a first network function are received; where the UE status information is configured to update a QoS specification for a first service, and the UE status information indicates UE status. A QoS update is performed based on the UE status information.

It should be noted that those skilled in the art can understand that the method provided in the embodiment of the present disclosure can be executed separately or together with some methods in the embodiments of the present disclosure or related technologies.

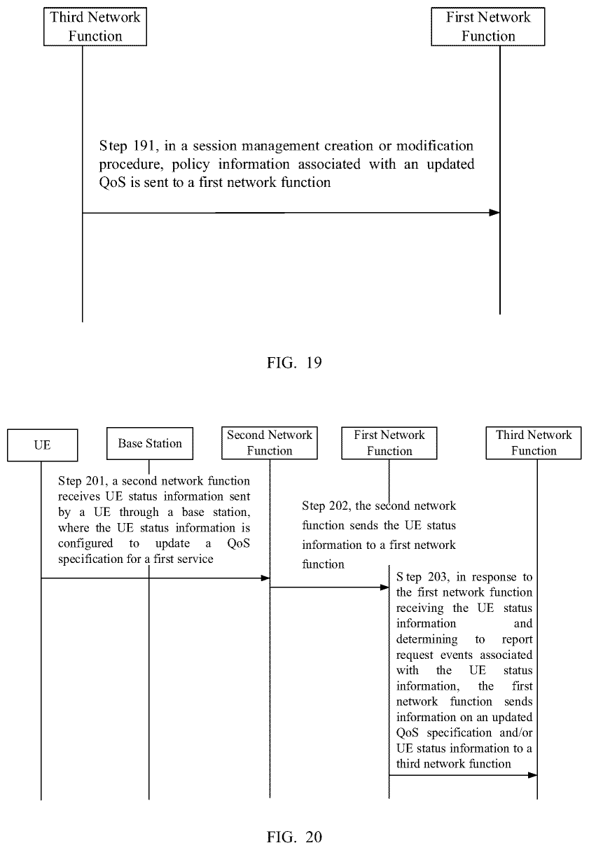

As shown in FIG. 19, this embodiment provides a wireless communication method. The method is performed by a third network function and includes step 191.

In step 191, in a session management creation or modification procedure, policy information associated with an updated QoS is sent to a first network function.

In an embodiment, information on an updated QoS specification and/or current UE status information of a UE sent by the first network function are received; where the UE status information is configured to update a QoS specification for a first service, and the UE status information indicates UE status. A QoS update is performed based on the UE status information. In a session management creation or modification procedure, policy information associated with an updated QoS is sent to the first network function.

It should be noted that those skilled in the art can understand that the method provided in the embodiment of the present disclosure can be executed separately or together with some methods in the embodiments of the present disclosure or related technologies.

As shown in FIG. 20, this embodiment provides a wireless communication method. The method is performed by a core network and includes steps 201 to 203.

In step 201, a second network function receives UE status information (sent by a UE through a base station), where the UE status information is configured to update a quality of service (QoS) specification for a first service.

In step 202, the second network function sends the UE status information to a first network function.

In step 203, in response to the first network function receiving the UE status information and determining to report request events associated with the UE status information, the first network function sends information on an updated QoS specification and/or the UE status information to a third network function.

The base station involved in the present disclosure can be of various types, for example, a base station of the third generation mobile communication (3G) network, a base station of the fourth generation mobile communication (4G) network, a base station of the fifth generation mobile communication (5G) network, or other evolved base station.

The network function involved in the present disclosure can be a device in a core network. In an embodiment, the first network function is an SMF, the second network function is an AMF, and the third network function is a PCF.

The terminal involved in the present disclosure may be, but is not limited to, a mobile phone, a wearable device, a vehicle-mounted terminal, a road side unit (RSU), a smart home terminal, an industrial sensing device, and/or a medical device. In some embodiments, the terminal may be a Redcap terminal or a predetermined version of a new radio (NR) terminal (for example, a R17 NR terminal).

In an embodiment, the first service includes at least one of the following: an extended reality and media (XRM) service; or a multi-modal service.

However, it should be noted that the first service is not limited to the XRM service and/or the multi-modal service, and can also be various general services or basic services, for example, terminal services, etc., which is not limited herein.

In an embodiment, the UE status information is information associated with terminal (UE) power supply.

In an embodiment, the UE status information includes at least one of the following: information on a battery level; information on a battery life; information on a powered mode, for example, the information on the powered mode can be information on a battery-powered mode and a wall-powered mode; information on a degree of heat generation, for example, the information on the degree of heat generation can be information on low heat status, medium heat status, and overheating status, etc.; or information on a central processing unit (CPU) load.

It should be noted that those skilled in the art can understand that the method provided in the embodiment of the present disclosure can be executed separately or together with some methods in the embodiments of the present disclosure or related technologies.

As shown in FIG. 21, this embodiment provides a wireless communication method. The method is performed by a core network and includes steps 211.

In step 211, UE status information is sent to a base station; where the UE status information is configured for the base station to update a quality of service (QoS) specification for a first service.

The base station involved in the present disclosure can be of various types, for example, a base station of the third generation mobile communication (3G) network, a base station of the fourth generation mobile communication (4G) network, a base station of the fifth generation mobile communication (5G) network, or other evolved base station.

The core network involved in the present disclosure can include one or more network functions, which can be devices in the core network, and the method can be performed by at least one network function.

The terminal involved in the present disclosure may be, but is not limited to, a mobile phone, a wearable device, a vehicle-mounted terminal, a road side unit (RSU), a smart home terminal, an industrial sensing device, and/or a medical device. In some embodiments, the terminal may be a Redcap terminal or a predetermined version of a new radio (NR) terminal (for example, a R17 NR terminal).

In an embodiment, the first service includes at least one of the following: an extended reality and media (XRM) service; or a multi-modal service.

However, it should be noted that the first service is not limited to the XRM service and/or the multi-modal service, and can also be various general services or basic services, for example, terminal services, etc., which is not limited herein.

In an embodiment, the UE status information is information associated with terminal (UE) power supply.

In an embodiment, the UE status information includes at least one of the following: information on a battery level; information on a battery life; information on a powered mode, for example, the information on the powered mode can be information on a battery-powered mode and a wall-powered mode; information on a degree of heat generation, for example, the information on the degree of heat generation can be information on low heat status, medium heat status, and overheating status, etc.; or information on a central processing unit (CPU) load.

In an embodiment, the UE status information is sent to the base station; where the UE status information is configured for the base station to update the QoS specification for the first service. Information on an updated QoS specification and/or the UE status information sent by the base station are received.

In an embodiment, the UE status information is sent to the base station; where the UE status information is configured for the base station to update the QoS specification for the first service. In a packet data unit (PDU) session modification procedure, the information on the updated QoS specification and/or the UE status information are received.

In an embodiment, the UE status information is sent to the base station; where the UE status information is configured for the base station to update the QoS specification for the first service. The information on the updated QoS specification and/or the UE status information are sent to a first network function through a N2 message. The N2 message indicates a reference to an alternative QoS profile and/or the UE status information, where the alternative QoS profile matches values of one or more fulfilled QoS parameters.

It should be noted that those skilled in the art can understand that the method provided in the embodiment of the present disclosure can be executed separately or together with some methods in the embodiments of the present disclosure or related technologies.

In order to better understand the embodiments of the present disclosure, the following are further illustrated by three exemplary embodiments.

In Example 1, it should be noted that the steps in this example are only illustrative, and other steps can refer to the session creation and update procedure in related technologies.

This embodiment provides an information transmission method, which includes steps S221 to S225, not shown.

In step S221, (AN initiated notification control) If notification control is configured for a GBR QoS Flow, (R) AN sends a N2 message (PDU Session ID, N2 SM information) to SMF when the (R) AN decides QoS targets of the QoS Flow cannot be fulfilled or can be fulfilled again, respectively. The N2 SM information includes QoS flow identity (QFI) and an indication that the QoS targets for that QoS Flow cannot be fulfilled or can be fulfilled again, respectively. When the QoS targets cannot be fulfilled, the N2 SM information indicates a reference to an Alternative QoS Profile matching values of QoS parameters (optionally, and corresponding UE status) that the NG-RAN is currently fulfilling. The AMF invokes Nsmf_PDUSession_UpdateSMContext (SM Context ID, N2 SM information). If the PCF has subscribed to the event, the SMF reports this event to the PCF for each policy control and charging (PCC) Rule for which notification control is set.

In step S222, the SMF may need to report some subscribed event to the PCF by performing an SMF initiated SM Policy Association Modification procedure. If dynamic PCC is not deployed, the SMF may apply local policy to decide whether to change the QoS profile.

In step S223, For UE or AN initiated modification, the SMF responds to the AMF through Nsmf_PDUSession_UpdateSMContext Response ([N2 SM information (PDU Session ID, QFI(s), QoS Profile(s), [Alternative QoS Profile(s)], Session-AMBR], [CN Tunnel Info(s)]), N1 SM container (PDU Session Modification Command (PDU Session ID, QoS rule(s), QoS rule operation, QoS Flow level QoS parameters if needed for the QoS Flow(s) associated with the QoS rule(s), Session-AMBR, [Always-on PDU Session Granted], [Port Management Information Container], [corresponding UE status]))). It should be noted that the Alternative QoS Profile is only valid for AN initiated modification.

The N2 SM information carries information that the AMF shall provide to the (R) AN. It may include the QoS profiles and the corresponding QFIs to notify the (R) AN that one or more QoS flows were added, or modified, and may include the corresponding UE status.

The N1 SM container carries the PDU Session Modification Command that the AMF shall provide to the UE. It may include the QoS rules, QoS Flow level QoS parameters (if needed) for the QoS Flow(s) associated with the QoS rule(s) and corresponding QoS rule operation and QoS Flow level QoS parameters operation to notify the UE that one or more QoS rules were added, removed or modified. It may include the corresponding UE status.

The SMF may need to send transparently through NG-RAN the PDU Session Modification Command to inform the UE, about changes in the QoS parameters (i.e., 5G QoS identifier (5QI), guaranteed flow bit rate (GFBR), maximum flow bit rate (MFBR)) that the NG-RAN is currently fulfilling after the SMF receives QoS Notification Control. When the SMF sends on the PDU Session Modification Command transparently through NG-RAN, the N2 SM information is not included as part of the Namf_Communication_NIN2MessageTransfer.

In step S224, the AMF may send N2 ([N2 SM information received from SMF], NAS message (PDU Session ID, N1 SM container (PDU Session Modification Command))) Message to the (R) AN.

In step S225, the (R) AN may issue AN specific signalling exchange with the UE that is related with the information received from SMF. For example, in the case of a NG-RAN, an RRC Connection Reconfiguration may take place with the UE modifying the necessary (R) AN resources related to the PDU Session or if only N1 SM container is received in step S224 from AMF, RAN transports only the N1 SM container to the UE. The (R) AN may consider the updated CN assisted RAN parameters tuning to reconfigure the AS parameters. As part of this, the N1 SM container is provided to the UE.

It should be noted that those skilled in the art can understand that the method provided in the embodiment of the present disclosure can be executed separately or together with some methods in the embodiments of the present disclosure or related technologies.

In Example 2, it should be noted that the steps in this example are only illustrative, and other steps can refer to the session creation and update procedure in related technologies.

In the Registration Request message (e.g., in the Initial Registration and the Mobility Registration Update as part of the UE 5 GMM Core Network Capability), the UE indicates in the PCO including UE status information (e.g. UE battery level, UE battery life, Powered mode including battery-powered or mains/wall-powered, UE overheating status).

This embodiment provides an information transmission method, which includes steps S231 to S235, not shown.

In step S231, the UE capability to support the provision of UE status information (e.g., UE battery level, UE battery life, Powered mode including battery-powered or mains/wall-powered, UE overheating status) included in the PCO in the PDU Session Establishment Request message.

In step S232, the AMF stores UE status information in the UE context. The corresponding SMF is selected and a request to create an SM context is sent, with the message carrying the N1 SM container in step 211, and the PCO carrying the UE status information.

In step S233, the SMF checks subscription data and/or event subscription, combined with local policies, to confirm whether the session can be created, whether to perform subscription event reporting, whether to perform a local policies and QoS authorization (if there is no PCF deployment, the SMF performs static rule activation and QoS authorization update), etc.

The SMF checks the event subscription (and/or in combination with subscription data or operator policies) to confirm whether to perform subscription event reporting. For example, if a UE status information event is subscribed, it is confirmed whether subscription reporting conditions are satisfied (for example, UE status changes, various thresholds are reached, or powered mode matches or changes, or immediate reporting or periodic reporting is received, etc.), and notification reporting is confirmed according to the subscription and reporting requirements. Or, the SMF confirms whether to transmit the UE status information to the PCF in combination with the subscription data and/or operator policies.

Here, the SMF sends the UE status information to the PCF in two ways: 1) the PCF sends a UE status information subscription request to the SMF, and the SMF reports the UE status information to the PCF after the reporting conditions are satisfied (the reporting conditions include, for example, receiving UE status information report, reporting periodically, reaching a certain reporting threshold for relevant status information, or receiving an immediate reporting instruction); 2) the SMF decides to send the UE status information to the PCF according to subscription information or operator policies.

For example, the SMF confirms whether the UE status information complies with user subscription and local policies (for example, whether the session can be created for the current UE status). If the session creation requirements are not met, the session creation for the XRM service/multi-modal service may be rejected, or the session creation may be received based on local policies but the XRM service/multi-modal service is not supported.

In step S234, if the PDU session uses dynamic PCC, the SMF performs PCF selection; otherwise, SMF performs local policies. This PDU session request supports the XRM service/multi-modal service. According to the subscription and application information provided by the AF, the SMF and PCF generate/activate corresponding XRM rules/multi-modal data rules, or generate/activate data flow PCC rules that enhance support XRM and multimodal sessions (for example, associating XRM service data flows, matching XRM service and multimodal service QoS, including GFBR, packet delay budget (PDB), maximum data burst volume (MDBV) matching of XRM and multi-modal service data flows, etc.).

The SMF reports the UE status information to the PCF. The PCF can perform the corresponding QoS update according to the received UE status information. The PCF triggers the SM session creation or modification procedure, and sends policy information to the SMF (for example, updated QoS information) for execution by the SMF (or UPF), RAN, and UE.

In step S235, in the SM session modification procedure, the PCF can provide QoS information updated based on the UE status information as in step S234 to the SMF for the UPF, RAN or UE to perform QoS updates for different registered data flows, as described in step S234.

It should be noted that those skilled in the art can understand that the method provided in the embodiment of the present disclosure can be executed separately or together with some methods in the embodiments of the present disclosure or related technologies.

In Example 3, it should be noted that the steps in this example are only illustrative, and other steps can refer to the session creation and update procedure in related technologies.

In the PDU session establishment process, UE status information is provided as 5 GSM Core Network Capability to the SMF, and then sent to the PCF through the SMF. The PCF performs a QoS update on UE, UE sessions, or UE service data flows according to the UE status information (for example, the QoS update is performed on all or part of XRM service data flows, or PDU sessions of the XRM service). The specific transmission and update processing of related network functions (NFs) are described in the following steps.

The UE indicates the UE 5 GSM Core Network Capability including the UE status information in PDU Session Establishment/Modification Request.

In step S241, not shown, the UE sends a non access stratum (NAS) message to the AMF, initiating the PDU session establishment procedure requested by the UE. The N1 SM container carries a session creation request, and the request message carries 5 GSM Capability, which includes UE status information to inform the network of the UE status information.

In step S242, the AMF stores the UE status information in the UE context. The corresponding SMF is selected and a request to create an SM context is sent, with the message carrying the N1 SM container in step S241, including the 5 GSM Core Network Capability which includes the UE status information.

It should be noted that other steps can refer to the description in Example 2.

It should be noted that those skilled in the art can understand that the method provided in the embodiment of the present disclosure can be executed separately or together with some methods in the embodiments of the present disclosure or related technologies.

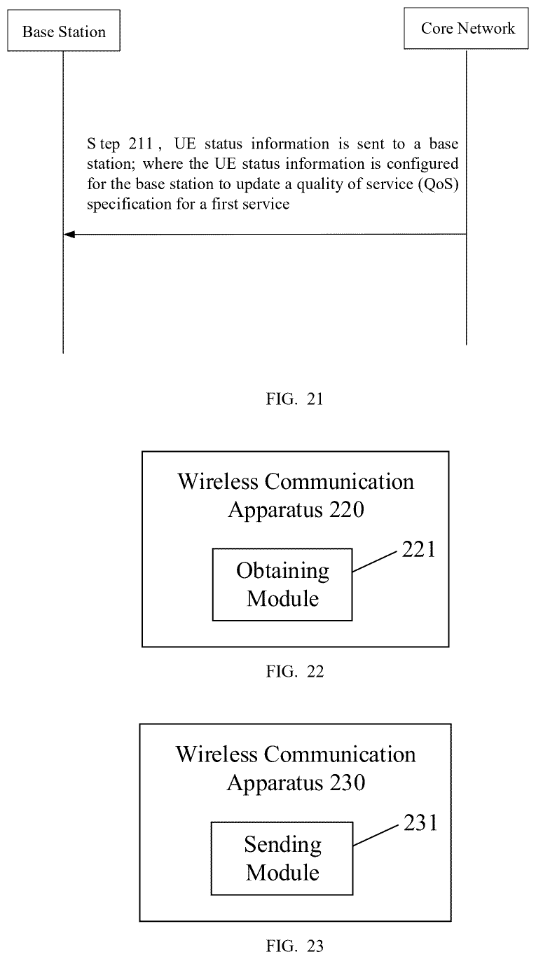

As shown in FIG. 22, this embodiment provides a wireless communication apparatus 220 which includes an obtaining module 221.

The obtaining module 221 is configured to obtain terminal status information from a first network function, where the terminal status information indicates terminal status; and update a quality of service (QoS) specification for a first service according to the terminal status information.

It should be noted that those skilled in the art can understand that the apparatuses provided in the embodiment of the present disclosure can be executed separately or together with some apparatuses in the embodiments of the present disclosure or related technologies.

As shown in FIG. 23, this embodiment provides a wireless communication apparatus 230 which includes a sending module 231.

The sending module 231 is configured to send terminal status information to a second network function; where the terminal status information is configured to update a quality of service (QoS) specification for a first service, and the terminal status information indicates terminal status.

It should be noted that those skilled in the art can understand that the apparatuses provided in the embodiment of the present disclosure can be executed separately or together with some apparatuses in the embodiments of the present disclosure or related technologies.

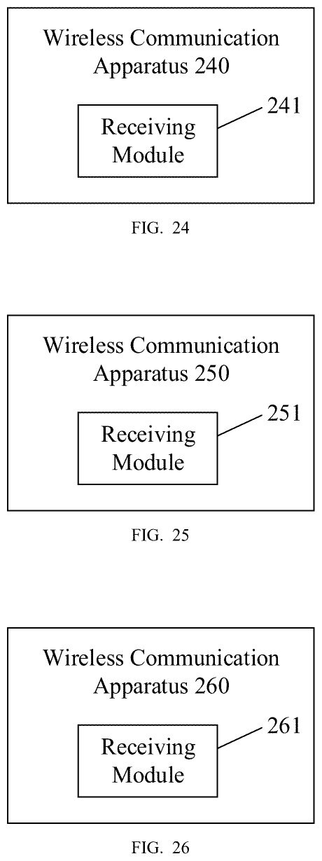

As shown in FIG. 24, this embodiment provides a wireless communication apparatus 240 which includes a receiving module 241.

The receiving module 241 is configured to receive terminal status information sent by a terminal; where the terminal status information is configured to update a quality of service (QoS) specification for a first service, and the terminal status information indicates terminal status.

It should be noted that those skilled in the art can understand that the apparatuses provided in the embodiment of the present disclosure can be executed separately or together with some apparatuses in the embodiments of the present disclosure or related technologies.

As shown in FIG. 25, this embodiment provides a wireless communication apparatus 250 which includes a receiving module 251.

The receiving module 251 configured to receive terminal status information sent by a second network function; where the terminal status information is configured to update a quality of service (QoS) specification for a first service, and the terminal status information indicates terminal status.

It should be noted that those skilled in the art can understand that the apparatuses provided in the embodiment of the present disclosure can be executed separately or together with some apparatuses in the embodiments of the present disclosure or related technologies.

As shown in FIG. 26, this embodiment provides a wireless communication apparatus 260 which includes a receiving module 261.

The receiving module 261 is configured to receive terminal status information sent by a first network function; where the terminal status information is configured to update a quality of service (QoS) specification for a first service, and the terminal status information indicates terminal status.

It should be noted that those skilled in the art can understand that the apparatuses provided in the embodiment of the present disclosure can be executed separately or together with some apparatuses in the embodiments of the present disclosure or related technologies.

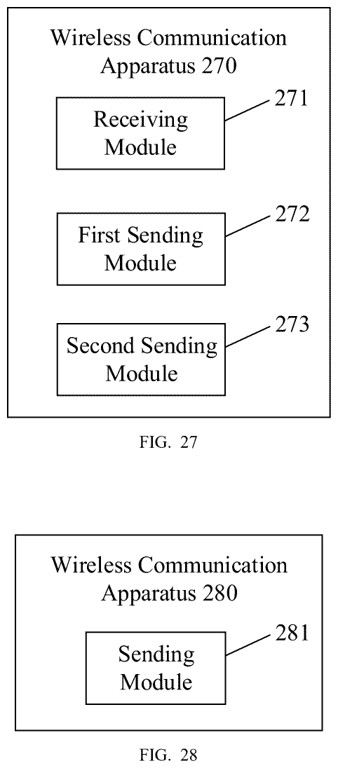

As shown in FIG. 27, this embodiment provides a wireless communication apparatus 270 which includes a receiving module 271, a first sending module 272, and a second sending module 273.

The receiving module 271 is configured for a second network function to receive terminal status information sent by a terminal through a base station, where the terminal status information is configured to update a quality of service (QoS) specification for a first service.

The first sending module 272 is configured for the second network function to send the terminal status information to a first network function.

The second sending module 273 is configured for the first network function to send information on an updated QoS specification and/or the terminal status information to a third network function in response to the first network function receiving the terminal status information and determining to report request events associated with the terminal status information.

It should be noted that those skilled in the art can understand that the apparatuses provided in the embodiment of the present disclosure can be executed separately or together with some apparatuses in the embodiments of the present disclosure or related technologies.

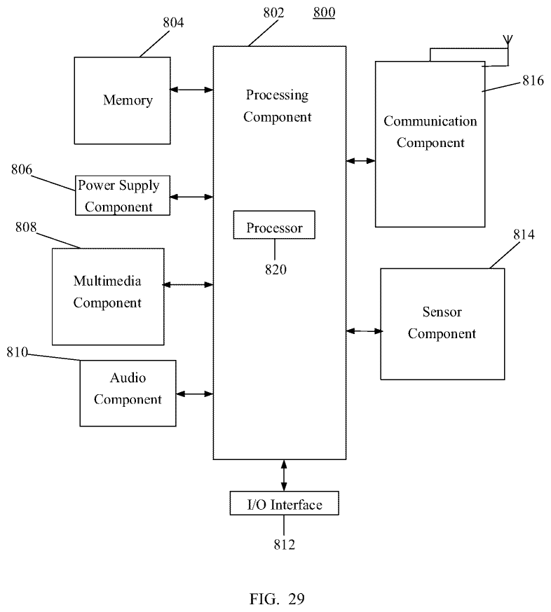

As shown in FIG. 28, this embodiment provides a wireless communication apparatus 280 which includes a sending module 281.

The sending module 281 is configured to send terminal status information to a base station; where the terminal status information is configured for the base station to update a quality of service (QoS) specification for a first service.

It should be noted that those skilled in the art can understand that the apparatuses provided in the embodiment of the present disclosure can be executed separately or together with some apparatuses in the embodiments of the present disclosure or related technologies.

An embodiment of the present disclosure provides a communication device, including: one or more processors; and a memory for storing instructions executable by the processors, where the processors are configured to, when executing the instructions, implement the method described in any embodiment of the present disclosure.

The processors may include various types of storage media, which are non-temporary computer-readable storage media that can continue to remember information stored on the communication device after power failure.

The processors can be connected to the memory through a bus or other means for reading executable programs stored on the memory.

An embodiment of the present disclosure also provides a non-transitory computer-readable storage medium storing a computer executable program that, when executed by a processor, implements the method described in any embodiment of the present disclosure.

Regarding the apparatuses in the embodiments, the specific ways in which each module performs operations have been described in detail in the relevant embodiments of the method, and will not be elaborated here.

As shown in FIG. 29, an embodiment of the present disclosure provides a structure of a terminal.

Referring to FIG. 29, the present embodiment provides a terminal 800. The terminal can specifically be a mobile phone, a computer, a digital broadcasting terminal, a messaging device, a game console, a tablet device, a medical device, a fitness device, a personal digital assistant, and the like.

Referring to FIG. 29, the terminal 800 can include one or more of the following components: a processing component 802, a memory 804, a power supply component 806, a multimedia component 808, an audio component 810, an input/output (I/O) interface 812, a sensor component 814 and a communication component 816.

The processing component 802 generally controls overall operations of the terminal 800, such as operations associated with display, phone calls, data communication, camera operations, and recording operations. The processing component 802 can include one or more processors 820 to execute instructions to complete all or part of the steps of the included methods. In addition, the processing component 802 can include one or more modules which facilitate the interaction between the processing component 802 and other components. For example, the processing component 802 can include a multimedia module to facilitate the interaction between the multimedia component 808 and the processing component 802.

The memory 804 is configured to store various types of data to support the operation of the terminal 800. Examples of such data include instructions for any application or method operated on the terminal 800, contact data, phonebook data, messages, pictures, videos, and so on. The memory 804 can be implemented by any type of volatile or non-volatile storage devices or a combination thereof, such as a Static Random Access Memory (SRAM), an Electrically Erasable Programmable Read Only Memory (EEPROM), an Erasable Programmable Read Only Memory (EPROM), a Programmable Read Only memory (PROM), a Read Only Memory (ROM), a magnetic memory, a flash memory, a magnetic or an optical disk.

The power supply component 806 provides power to various components of the terminal 800. The power supply component 806 can include a power management system, one or more power supplies, and other components associated with generating, managing, and distributing power for the terminal 800.

The multimedia component 808 includes a screen providing an output interface between the terminal 800 and a user. In some examples, the screen may include a liquid crystal display (LCD) and a touch panel (TP). If the screen includes the TP, the screen can be implemented as a touch screen to receive input signals from the user. The TP includes one or more touch sensors to sense touches, swipes, and gestures on the TP. The touch sensor can not only sense a boundary of a touch or swipe, but also sense a lasting time and a pressure associated with the touch or swipe. In some embodiments, the multimedia component 808 can include a front camera and/or a rear camera. The front camera and/or rear camera can receive external multimedia data when the terminal 800 is in an operating mode, such as a photographing mode or a video mode. Each of the front camera and the rear camera can be a fixed optical lens system or have focal length and optical zooming capability.

The audio component 810 is configured to output and/or input an audio signal. For example, the audio component 810 includes a microphone (MIC). When the terminal 800 is in an operating mode, such as a call mode, a recording mode, and a voice recognition mode, the MIC is configured to receive an external audio signal. The received audio signal may be further stored in the memory 804 or transmitted via the communication component 816. In some embodiments, the audio component 810 further includes a speaker to output an audio signal.

The I/O interface 812 can provide an interface between the processing component 802 and peripheral interface modules. The peripheral interface modules can include a keyboard, a click wheel, buttons and so on. These buttons can include, but are not limited to, a home button, a volume button, a starting button and a locking button.

The sensor component 814 includes one or more sensors to provide status assessments of various aspects for the terminal 800. For example, the sensor component 814 can detect the on/off status of the terminal 800, and relative positioning of a component, for example, the component is a display and a keypad of the terminal 800. The sensor component 814 may also detect a change in position of the terminal 800 or a component of the terminal 800, a presence or absence of the contact between a user and the terminal 800, an orientation or an acceleration/deceleration of the terminal 800, and a change in temperature of the terminal 800. The sensor component 814 can include a proximity sensor configured to detect the presence of a nearby object without any physical contact. The sensor component 814 can further include an optical sensor, such as a Complementary Metal Oxide Semiconductor (CMOS) or Charge-coupled Device (CCD) image sensor which is used in imaging applications. In some embodiments, the sensor component 814 can further include an acceleration sensor, a gyroscope sensor, a magnetic sensor, a pressure sensor, or a temperature sensor.

The communication component 816 is configured to facilitate wired or wireless communication between the terminal 800 and other devices. The terminal 800 can access a wireless network that is based on communication standards, such as Wi-Fi, 4G, 5G, or a combination thereof. In an exemplary embodiment, the communication component 816 receives a broadcast signal or broadcast-associated information from an external broadcast management system via a broadcast channel. In an exemplary embodiment, the communication component 816 further includes a Near Field Communication (NFC) module to facilitate short-range paging. For example, the NFC module can be implemented based on a Radio Frequency Identification (RFID) technology, an Infrared Data Association (IrDA) technology, an Ultra-Wide Band (UWB) technology, a Blue Tooth (BT) technology and other technologies.

In an exemplary embodiment, the terminal 800 can be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components for performing any of the methods.

In an exemplary embodiment, there is also provided a non-transitory machine readable storage medium including instructions, such as the memory 804 including instructions. The instructions may be executed by the processor 820 of the terminal 800 to perform any of the methods. For example, the non-transitory machine readable storage medium can be a ROM, a Random Access Memory (RAM), a CD-ROM, a magnetic tape, a floppy disk, an optical data storage device, and the like.

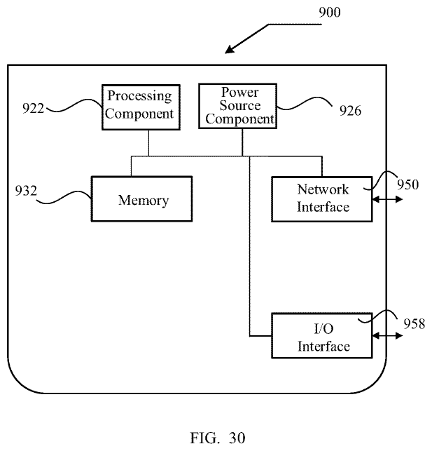

As shown in FIG. 30, an embodiment of the present disclosure illustrates the structure of a base station. For example, the base station 900 can be provided as a network side device. Referring to FIG. 30, the base station 900 includes a processing component 922 which further includes one or more processors, and a memory resource represented by a memory 932, configured to store instructions such as application programs executable by the processing component 922. The application programs stored in the memory 932 can include one or more than one modules, each of which corresponds to a set of instructions. In addition, the processing component 922 is configured to execute the instructions to perform any of the methods applied to the base station.

The base station 900 can further include a power source component 926 configured to execute power management of the base station 900, a wired or wireless network interface 950 configured to connect the base station 900 to a network, and an I/O interface 958. The base station 900 can be operated on the basis of an operating system stored in the memory 932, such as Windows Server™, Mac OS X™, Unix™, Linux™ or FreeBSD™.

Those skilled in the art will readily recognize other embodiments of the present disclosure upon consideration of the specification and practice of the present disclosure disclosed herein. The present disclosure is intended to cover any variations, uses, or adaptations of the present disclosure, which follow general principles of the embodiments of the present disclosure and include common knowledge or customary means in the art that are not disclosed in the present disclosure. The specification and embodiments are exemplary only, with the true scope and spirit of the present disclosure being indicated by the following claims.

It should be understood that the present disclosure is not limited to the precise structure that has been described herein and shown in the drawings, and various modifications and changes may be made without departing from the scope thereof. The scope of the present disclosure is limited only by the appended claims.

1. A wireless communication method, performed by a base station, the method comprising:
obtaining terminal status information from a first network function; and
updating a quality of service (QoS) specification for a first service according to the terminal status information.

2. The method according to claim 1, wherein the method comprises at least one of:
the first network function is a session management function (SMF);
the first service comprises at least one of: an extended reality and media (XRM) service; or a multi-modal service; or
the terminal status information comprises at least one of: information on a battery level; information on a battery life; information on a powered mode; information on a degree of heat generation; or information on a central processing unit (CPU) load.

3. (canceled)

4. The method according to claim 1, wherein updating the QoS specification for the first service according to the terminal status information comprises:
updating the QoS specification according to the terminal status information and a mapping relationship between terminal status and QoSs; or
updating the QoS specification according to the terminal status information and indication information on terminal status management;
wherein the mapping relationship is indicated by at least one of: indication information issued by a policy control function (PCF), QoS profile indication information, or operator policies indication information.

5. (canceled)

6. The method according to claim 1, further comprising:
sending information on an updated QoS specification and/or the terminal status information to a predetermined object;
wherein the predetermined object comprises at least one of:
a network function of a core network,
a terminal, or
an application function (AF).

7. The method according to claim 6, wherein sending the information on the updated QoS specification and/or the terminal status information to the predetermined object comprises at least one of:
in a packet data unit (PDU) session modification procedure, sending the information on the updated QoS specification and/or the terminal status information to the predetermined object; or
sending the information on the updated QoS specification and/or the terminal status information to the first network function through a N2 message; wherein the N2 message indicates a reference to an alternative QoS profile and/or the terminal status information, wherein the alternative QoS profile matches values of one or more fulfilled QoS parameters.

8. The method according to claim 6, wherein sending the information on the updated QoS specification and/or the terminal status information to the predetermined object comprises:
in response to notification control being configured for a guaranteed bit rate (GBR) QoS flow and a target QoS specification of the QoS flow cannot be fulfilled, sending the information on the updated QoS specification and/or the terminal status information to the first network function; or
in response to the notification control being configured for the GBR QoS flow, and the target QoS specification of the QoS flow being fulfilled again after the QoS specification is adjusted based on a result that the target QoS specification of the QoS flow cannot be fulfilled, sending the information on the updated QoS specification and/or the terminal status information to the first network function.

9. (canceled)

10. The method according to claim 1, wherein updating the QoS specification for the first service comprises:
updating the QoS specification based on information on an alternative QoS parameter set; and
wherein the information on the alternative QoS parameter set comprises at least one of:
alternative QoS parameters for a guaranteed bit rate (GBR) data flow, wherein the alternative QoS parameters comprise an averaging window and a maximum data burst volume, or
indication information on terminal status management.

11. (canceled)

12. A wireless communication method, performed by a terminal, the method comprising:
sending terminal status information to a second network function, and
wherein the terminal status information is configured to update a quality of service (QoS) specification for a first service.

13-14. (canceled)

15. The method according to claim 12, wherein sending the terminal status information to the second network function comprises:
in a packet data unit (PDU) session establishment procedure, sending the terminal status information to the second network function through a protocol configuration option (PCO) of a PDU session establishment request; or
in the PDU session establishment procedure, sending the terminal status information to the second network function through a session management core network capability of the PDU session establishment request.

16. The method according to claim 12, further comprising:
receiving information on at least one of an updated QoS specification or the terminal status information sent by a base station.

17. (canceled)

18. A wireless communication method, performed by a second network function, the method comprising:
receiving terminal status information sent by a terminal, and
wherein the terminal status information is configured to update a quality of service (QoS) specification for a first service.

19-20. (canceled)

21. The method according to claim 18, wherein receiving the terminal status information sent by the terminal comprises:
in a packet data unit (PDU) session establishment procedure, receiving the terminal status information sent by the terminal through a protocol configuration option (PCO) of a PDU session establishment request; or
in the PDU session establishment procedure, receiving the terminal status information sent by the terminal through a session management core network capability of the PDU session establishment request.

22. The method according to claim 18, wherein further comprising:
determining a first network function; and
sending the terminal status information to the first network function.

23. The method according to claim 22, wherein the method comprises at least one of:
the first network function is a session management function (SMF); or
sending the terminal status information to the first network function comprises:
in a packet data unit (PDU) session establishment procedure, sending the terminal status information to the first network function through a protocol configuration option (PCO) for creating a session management (SM) context request; or
in the PDU session establishment procedure, sending the terminal status information to the first network function through a session management core network capability for creating the SM context request.

24-60. (canceled)

61. A communication device, comprising:
a memory; and
one or more processors, connected to the memory, configured to execute computer executable instructions stored on the memory to implement the method according to claim 1.

62. (canceled)

63. A communication device, comprising:
a memory; and
one or more processors, connected to the memory, configured to execute computer executable instructions stored on the memory to implement the method according to claim 12.

64. A communication device, comprising:
a memory; and
one or more processors, connected to the memory, configured to execute computer executable instructions stored on the memory to implement the method according to claim 18.

65. A non-transitory computer storage medium storing computer executable instructions that, when executed by a processor, implement the method according to claim 1.

66. A non-transitory computer storage medium storing computer executable instructions that, when executed by a processor, implement the method according to claim 12.

67. A non-transitory computer storage medium storing computer executable instructions that, when executed by a processor, implement the method according to claim 18.
